(19) United States
(12) Patent Application Publication
(10) Pub. No.: US 2013/0341167 A1
(43) Pub. Date: Dec. 26, 2013

(54) TOUCH PANEL DEVICE

(71) Applicant: WINTEK CORPORATION, Taichung City (TW)

(72) Inventors: Yi-Chun Wu, Hualien County (TW); Yu-Chen Liu, Taipei City (TW); Wun-Yi Shie, Taichung City (TW); Chung-Hui Hu, Yunlin County (TW)

(21) Appl. No.: 13/923,350

(22) Filed: Jun. 20, 2013

(30) Foreign Application Priority Data
Jun. 22, 2012 (TW) 101122415

(51) Int. Cl. H01H 1/02

(52) U.S. Cl. CPC H01H 1/02
USPC 200/267

(57) ABSTRACT

A touch panel device includes a transparent substrate, at least one decorative layer, a plurality of light transmission conductive traces, and a reflection layer. The transparent substrate has a border region. A light transmission sensing electrode layer is formed on a surface of the transparent substrate corresponding to the border region. The decorative layer is formed on the border region. The plurality of light transmission conductive traces is alternately formed on the decorative layer and electrically connected to the light transmission sensing electrode layer, for transmitting signals generated by the light transmission sensing electrode layer. The reflection layer is disposed on a side of the plurality of light transmission conductive traces for reflecting light passing through the decorative layer and the plurality of light transmission conductive traces.

### BACKGROUND OF THE INVENTION

1. Field of the Invention

The present invention relates to a touch panel device, and more specifically, to a touch panel device of utilizing light transmission conductive traces to replace metal traces and utilizing a reflection layer to reflect light.

2. Description of the Prior Art

In general, a touch panel device usually utilizes a design in which metal traces are disposed under a border region coated with a decorative layer to electrically connect to a light transmission sensing electrode layer and a flexible circuit board, so as to achieve the purpose of covering the metal traces. The conventional configuration is as shown in FIG. 1, which is a partial diagram of a touch panel device 10 according to the prior art. As shown in FIG. 1, the touch panel device 10 includes a transparent substrate 12, a decorative layer 14, and a plurality of metal traces 16. The transparent substrate 12 has a border region 18, and a light transmission sensing electrode layer 20 is formed on a surface of the transparent substrate 12 corresponding to the border region 18. The decorative layer 14 is formed on the border region 18. The plurality of metal traces 16 is alternately formed on the decorative layer 14 and electrically connected to the light transmission sensing electrode layer 20 for transmitting signals generated by the light transmission sensing electrode layer 20.

However, if the decorative layer 14 is a white or color decorative layer with preferable transparency, light could pass through the decorative layer 14 partially or through an interval between adjacent metal traces 16 (as shown in FIG. 1) to be incident into the metal traces 16. At this time, due to the high reflectivity of the metal traces 16, the light incident into the metal traces 16 could be reflected by the metal traces 16 and then emitted out of the transparent substrate 12, so as to cause excessive brightness variation on the transparent substrate 12 of the touch panel device 10. The aforesaid condition may cause a user to view the metal traces 16 and the border region 18 of impure color rendition, so as to influence the outer appearance of the touch panel device 10 and make the user visually uncomfortable when viewing the touch panel device 10.

### SUMMARY OF THE INVENTION

The present invention provides a touch panel device including a transparent substrate, at least one decorative layer, a plurality of light transmission conductive traces, and a reflection layer. The transparent substrate has a border region. The decorative layer is formed on the border region. A light transmission sensing electrode layer is formed on a side of the transparent substrate with the decorative layer. The plurality of light transmission conductive traces is alternately formed on the decorative layer and electrically connected to the light transmission sensing electrode layer, for transmitting signals generated by the light transmission sensing electrode layer. The reflection layer is disposed on a side of the plurality of light transmission conductive traces for reflecting light passing through the decorative layer and the plurality of light transmission conductive traces.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a partial diagram of a touch panel device according to the prior art.

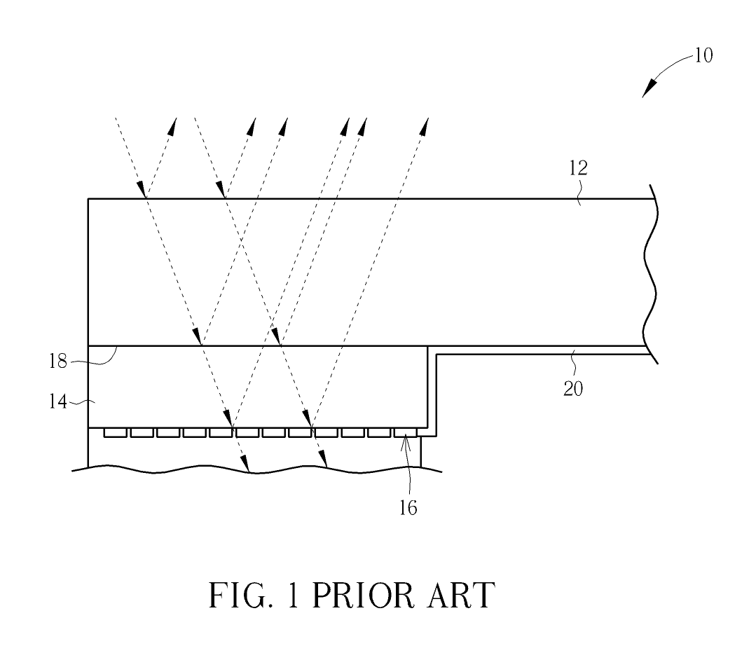

FIG. 2 is a partial diagram of a touch panel device according to an embodiment of the present invention.

### DETAILED DESCRIPTION

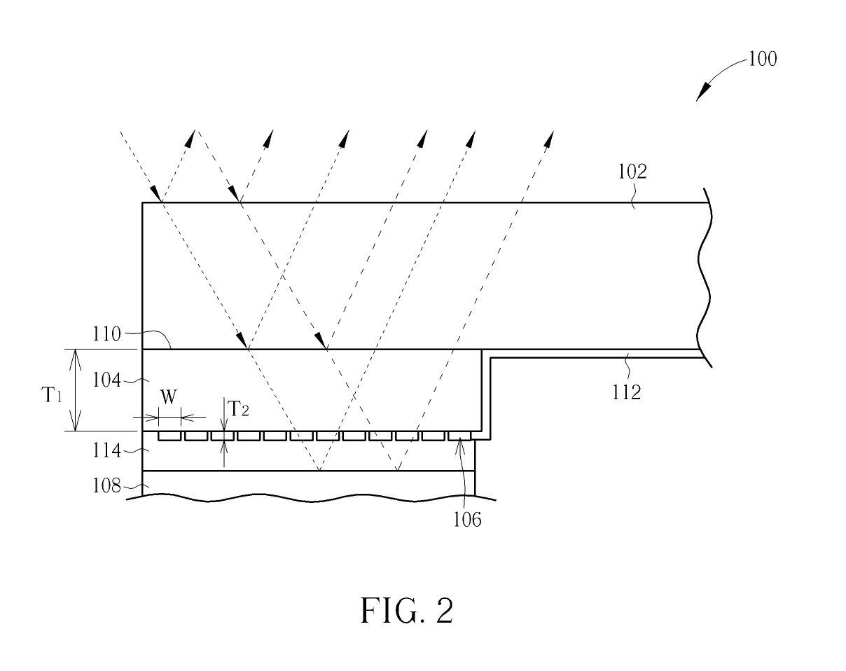

Please refer to FIG. 2, which is a partial diagram of a touch panel device 100 according to an embodiment of the present invention. As shown in FIG. 2, the touch panel device 100 includes a transparent substrate 102, at least one decorative layer 104 (one shown in FIG. 2, but not limited thereto), a plurality of light transmission conductive traces 106, and a reflection layer 108. The transparent substrate 102 could be a light transmission sheet commonly applied to a conventional touch panel, such as a cover glass. The transparent substrate 102 has a border region 110, and a light transmission sensing electrode layer 112 is formed on a side of the transparent substrate 102 corresponding to the border region 110. In this embodiment, the light transmission sensing electrode layer 112 could utilize a conventional touch sensing method (e.g. a capacitance variation detecting method) to detect a corresponding touch position on the transparent substrate 102 when a user touches the transparent substrate 102. Description for the related electrode configuration and electrode forming process of the light transmission sensing electrode layer 112 is commonly seen in the prior art and then omitted herein for simplicity. More detailed description for the designs of the decorative layer 104, the plurality of light transmission conductive traces 106, and the reflection layer 108 is provided as follows.

As shown in FIG. 2, the decorative layer 104 is formed on the border region 110. In this embodiment, the decorative layer 104 is a color or white decorative layer, such as a color (e.g. red) or a white ink layer formed on the border region 110 by a printing process, but not limited thereto, meaning that the decorative layer 104 could also be a black ink layer or a photo-resist layer (e.g. a black, color, or white photo-resist layer formed by a chemical deposition method). Accordingly, the touch panel device 100 could utilize the decorative layer 104 to decorate the outer appearance of the touch panel device 100 and cover inner traces of the touch panel device 100.

The plurality of light transmission conductive traces 106 is alternately formed on the decorative layer 104 and electrically connected to the light transmission sensing electrode layer 112 for transmitting signals generated by the light transmission sensing electrode layer 112. In this embodiment, the plurality of light transmission conductive traces 106 is made of light transmission conductive material, such as ITO (indium Tin Oxide), CNT (Carbon Nanotube), or nano-silver material.

To more specific, material of the light transmission conductive trace 106 could be the same as that of the light transmission sensing electrode layer 112. In such a manner, forming of the light transmission conductive traces 106 could be performed simultaneously during the forming process of the light transmission sensing electrode layer 112. Accordingly, in the present invention, there is no need to additionally perform the forming process of the light transmission conductive traces 106 after the forming process of the light transmission sensing electrode layer 112 is completed, so as to reduce the process time of the touch panel device 100.

The reflection layer 108 is disposed on a side of the plurality of light transmission conductive traces 106. The reflection layer 108 is preferably made of high reflectivity material, such as silver or chromium, for totally reflecting light passing through the decorative layer 104 and the plurality of light transmission conductive traces 106. Furthermore, as shown in FIG. 2, the touch panel device 100 further includes at least one insulation layer 114 (one shown in FIG. 2, but not limited thereto). The insulation layer 114 is formed on the plurality of light transmission conductive traces 106 to prevent adjacent light transmission conductive traces 106 from contacting with each other, and the reflection layer 108 is disposed on the insulation layer 114.

Via the aforesaid configuration, even if the decorative layer 104 is a white ink layer (or a color ink layer) or a white photo-resist layer (or a color photo-resist layer) with preferable transparency so as to allow light to pass through the decorative layer 104 (as shown in FIG. 2) and then to be incident into the light transmission conductive traces 106, the light transmission conductive traces 106 could still allow the light to pass through due to its high transparency and then the light could be totally reflected back by the reflection layer 108, so that the touch panel device 100 could efficiently solve the prior art problem that excessive brightness variation may occur on the transparent substrate of the touch panel device due to the high reflectivity of the metal traces and the metal traces may be viewed by a user. Furthermore, the present invention could also solve the prior art problem that a user views the border region of impure color rendition, and could further utilize the reflection layer 108 to cover inner components (e.g. a backlight module) of the touch panel device 100 and prevent light leakage, so as to improve the appearance quality and visual comfort of the touch panel device 100.

To be noted, since the plurality of light transmission conductive traces 106 could allow light to pass through, there is no need for the touch panel device 100 to increase the thickness of the decorative layer 104 for covering the plurality of light transmission conductive traces 106, meaning that the thickness of the decorative layer 104 could be further reduced in the present invention. For example, if the decorative layer 104 is a photo-resist layer, the present invention could reduce a thickness T₁ of the decorative layer 104 to fall within a range between 0.5 μm and 2 μm (preferably between 1 μm and 1.5 μm). On the other hand, if the decorative layer 104 is an ink layer, the present invention could reduce the thickness T₁ of the decorative layer 104 to fall within a range between 3 μm and 20 μm (preferably between 5 μm and 10 μm). In such a manner, the aforesaid design could efficiently prevent breaking of the light transmission sensing electrode layer caused by the excessive thickness of the decorative layer, and further reduce the material cost of the touch panel device 100.

Furthermore, for further preventing the touch panel device 100 from having an excessively high resistance after utilizing the light transmission conductive traces 106 to replace metal traces, in the present invention, the touch panel device 100 could enlarge the size of each light transmission conductive trace 106 (e.g. increasing the width or the thickness of each light transmission conductive trace 106) or modify the electrical connection design of each light transmission conductive trace 106 and the light transmission sensing electrode layer 112, so as to achieve the purpose of reducing the overall resistance of the touch panel device 100. For example, the present invention could increase a width W of each light transmission conductive trace 106 to fall within a range between 10 μm and 5 mm, or increase a thickness T₂ of each light transmission conductive trace 106 to fall within a range between 100 A and 100 μm. In another embodiment, the plurality of light transmission conductive traces 106 could be designed to be in serial connection with the light transmission sensing electrode layer 112 by electrically connecting to two ends of the light transmission sensing electrode layer 112, which is usually called as a double routing design.

In summary, the touch panel device provided by the present invention utilizes the light transmission conductive traces to replace metal traces and further utilizes the reflection layer to reflect light passing through the decorative layer and the light transmission conductive traces, so as to solve the prior art problem that excessive brightness variation may occur on the transparent substrate of the touch panel device due to the high reflectivity of the metal traces and the metal traces may be viewed by a user. Furthermore, the present invention could also solve the prior art problem that a user views the border region of impure color rendition, and could further utilize the reflection layer to cover inner components (e.g. a backlight module) of the touch panel device and prevent light leakage, so as to improve the appearance quality and visual comfort of the touch panel device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel device comprising:
a transparent substrate having a border region;
at least one decorative layer formed on the border region;
a light transmission sensing electrode layer formed on a side of the transparent substrate with the decorative layer;
a plurality of light transmission conductive traces alternately formed on the decorative layer and electrically connected to the light transmission sensing electrode layer, for transmitting signals generated by the light transmission sensing electrode layer; and
a reflection layer disposed on a side of the plurality of light transmission conductive traces for reflecting light passing through the decorative layer and the plurality of light transmission conductive traces.

2. The touch panel device of claim 1, wherein the decorative layer is a photo-resist layer, and a thickness of the decorative layer falls within a range between 0.5 μm and 2 μm.

3. The touch panel device of claim 2, wherein the thickness of the decorative layer falls within a range between 1 μm and 1.5 μm.

4. The touch panel device of claim 1, wherein the decorative layer is an ink layer, and a thickness of the decorative layer falls within a range between 3 μm and 20 μm.

5. The touch panel device of claim 4, wherein the thickness of the decorative layer falls within a range between 5 μm and 10 μm.

6. The touch panel device of claim 1 further comprising:
at least one insulation layer formed on the plurality of light transmission conductive traces, wherein the reflection layer is disposed on the insulation layer.

7. The touch panel device of claim 1, wherein the plurality of light transmission conductive traces is in serial connection with the light transmission sensing electrode layer by electrically connecting to two ends of the light transmission sensing electrode layer.

8. The touch panel device of claim 1, wherein the decorative layer is a color decorative layer or a white decorative layer.

9. The touch panel device of claim 1, wherein each light transmission conductive trace is made of ITO (Indium Tin Oxide), CNT (Carbon Nanotube), or nano-silver material.

10. The touch panel device of claim 1, wherein material of each light transmission conductive trace is the same as material of the light transmission sensing electrode layer.

11. The touch panel device of claim 1, wherein reflection material of the reflection layer is selected from silver or chromium.
